(19) United States
(12) Patent Application Publication
(10) Pub. No.: US 2025/0111202 A1
(43) Pub. Date: Apr. 3, 2025

(54) DYNAMIC PROMPT CREATION FOR LARGE LANGUAGE MODELS

(71) Applicant: Microsoft Technology Licensing, LLC, Redmond, WA (US)

(72) Inventors: MohammadReza GHAEINI, Seattle, WA (US); Can LI, Redmond, WA (US); Bin ZHANG, Kirkland, WA (US)

(73) Assignee: Microsoft Technology Licensing, LLC, Redmond, WA (US)

(21) Appl. No.: 18/477,760

(22) Filed: Sep. 29, 2023

(51) Int. Cl. G06N 3/0455; G06N 3/0475

(52) U.S. Cl. CPC G06N 3/0455; G06N 3/0475

(57) ABSTRACT

The technology relates to systems and methods for dynamically generating prompts for a generative artificial intelligence (AI) model. An example method includes receiving input content for evaluation by a generative AI model; receiving an input-content embedding for the input content; receiving trait data and trait-data embeddings for the trait data; identifying similar trait data by comparing the input-content embedding with the trait-data embeddings, wherein the similar trait data is a subset of the trait data that is similar to the input content; generating a prompt including the input content and the identified similar trait data; providing the prompt to the generative AI model; and receiving, from the generative AI model in response to the prompt, an output payload including an evaluation of the input content.

### BACKGROUND

Large language models (LLMs) and other generative artificial intelligence (AI) have provided significant advances in technology and also have vast applicability to a variety of tasks and industries. LLMs, however, are quite computationally expensive and resource-demanding solutions. It is with respect to these and other considerations that examples have been made. In addition, although relatively specific problems have been discussed, it should be understood that the examples should not be limited to solving the specific problems identified in the background.

### SUMMARY

Examples described in this disclosure relate to systems and methods that dynamically generate prompts for generative AI models based on the input content. The dynamic generation of the prompts results in prompts that are more computationally efficient while preserving the clarity and quality of the prompts. With the dynamic prompt generation, the input content is preprocessed to determine which categories and/or examples are most closely related to the input content. Based on that similarity determination, only the examples and/or categories that are determined to be most closely related (e.g., exceeding a similarity metric) are incorporated into the prompt. This allows for the examples and/or categories that are least likely to be useful for evaluation of the input content to be omitted from the prompt. Accordingly, the dynamically generated prompt allows for improved computational performance by the LLM (when the LLM processes the prompt) while still retaining the data that is most likely to lead to an accurate evaluation of the input content.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example by the accompanying figures, in which like references indicate similar elements. Elements in the figures are illustrated for simplicity and clarity and have not necessarily been drawn to scale.

FIG. 1 is a block diagram of an example dynamic prompt generation system.

FIG. 2 is a block diagram of example components of an example dynamic prompt generation system.

FIG. 3 is an example data flow for dynamically generating a prompt for a language model.

FIG. 4 is an example method for dynamically generating a prompt for a language model.

FIG. 5 is a block diagram illustrating example physical components of a computing device with which aspects of the disclosure may be practiced.

### DETAILED DESCRIPTION

As discussed briefly above, the use of LLMs provides solutions for a wide variety of applications. However, LLMs are also resource-intensive solutions. LLMs are often configured to process a prompt that may include natural language instructions and/or requests for the LLM to process. For example, the prompt may be an input sequence that typically includes text data but may also include other modes of input (e.g., image data). The input sequence is provided as input to the LLM and processed by the LLM to generate a responsive output. The quality and/or clarity of the AI prompt affects the accuracy of the response that is provided by the LLM.

In addition, the size and configuration of the prompt also affects the performance of the LLM. For instance, with some LLMs, the prompt is tokenized into tokens, and additional tokens require additional computations. In some examples, the processing requirements grow exponentially with the number of tokens. The memory usage for the model also increases as the number of tokens increases. In some implementations, there are also limits placed on the length of the prompt. Thus, shorter prompts provide for faster processing of the prompt and/or a smaller memory footprint. Nevertheless, reducing the length of the prompt may require the omission of data that may have otherwise improved the clarity and/or quality of the prompt.

In some instances, the prompts may include explicit examples that help guide the LLM to provide a more accurate response, such as a more accurate classification. The use of such examples may be particularly useful in areas where the examples are rapidly changing, such as in classification tasks for current events. As one example, the classification task may be to classify a particular phrase or input content as misinformation or not. In such an example, the prompt is populated with examples of phrases that are pre-tagged as misinformation. The LLM can then use these examples effectively as a ground truth for performing the classification of the input content. As should be appreciated, there are a vast number of examples of misinformation, and categories of misinformation, that can be compiled and tagged. Thus, incorporating all the possible examples of misinformation into the prompt increases the computing resources required to process the prompt by the LLM. The increased computing resources also often leads to increased latency in generating the response.

The technology disclosed herein, among other things, provides solutions to the above problem by providing systems and methods that dynamically generate prompts based on the input content. The dynamic generation of the prompts results in prompts that are more computationally efficient while preserving the clarity and quality of the prompts. With the dynamic prompt generation, the input content is preprocessed to determine which categories and/or examples are most closely related to the input content. Based on that similarity determination, only the examples and/or categories that are determined to be most closely related (e.g., exceeding a similarity metric) are incorporated into the prompt. This allows for the examples and/or categories that are least likely to be useful for evaluation of the input content to be omitted from the prompt. Accordingly, the dynamically generated prompt allows for improved computational performance by the LLM (when the LLM processes the prompt) while still retaining the data that is most likely to lead to an accurate evaluation of the input content.

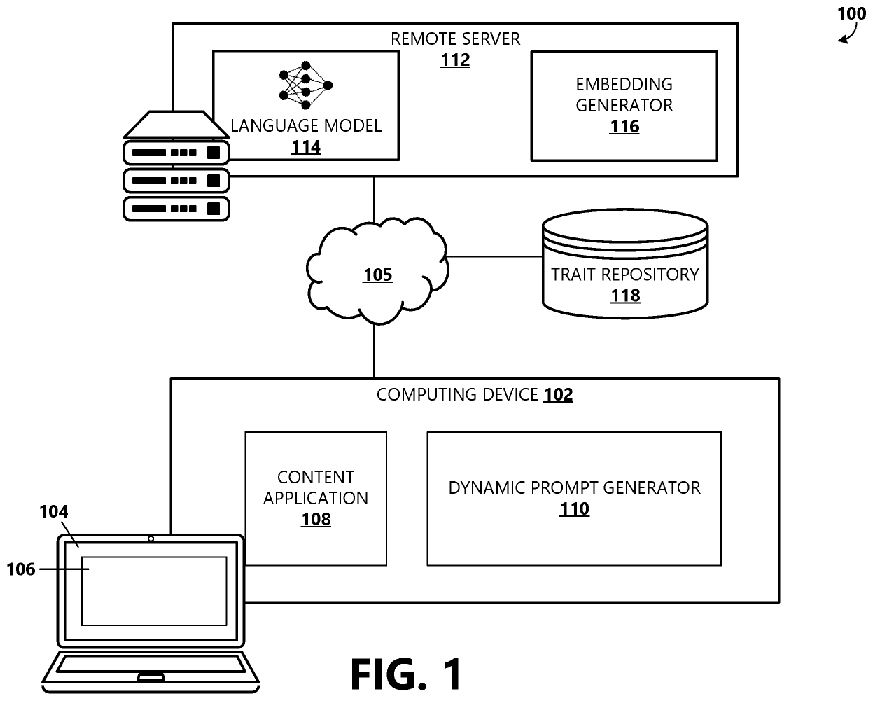

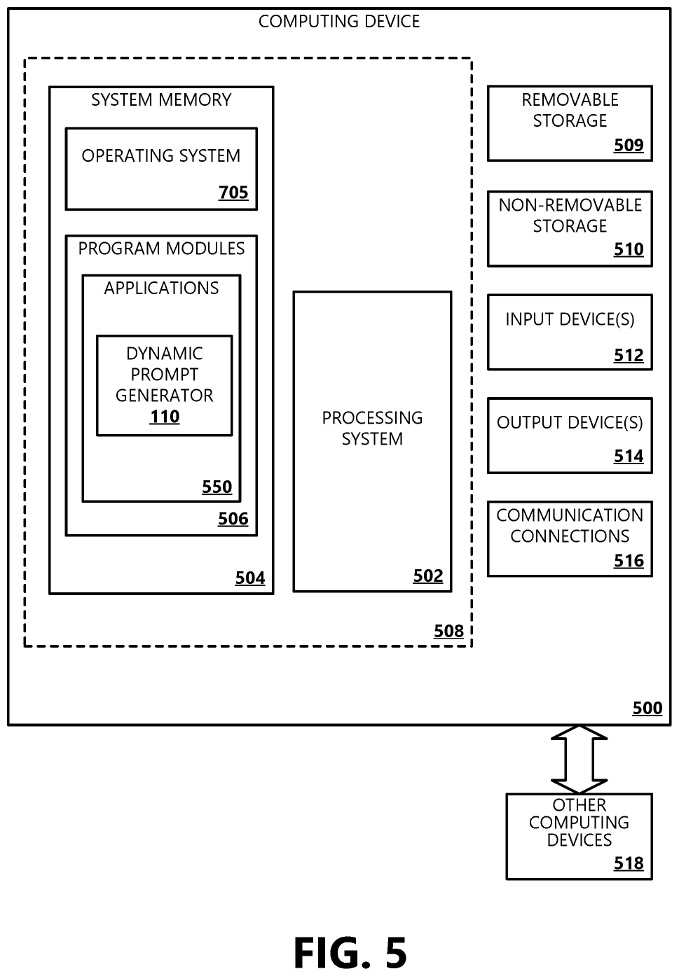

FIG. 1 is a block diagram of an example system 100 for dynamically generating prompts. The example system 100, as depicted, is a combination of interdependent components that interact to form an integrated whole. Some components of the system 100 are illustrative of software applications, systems, or modules that operate on a computing device or across a plurality of computer devices. Any suitable computer device(s) may be used, including web servers, application servers, network appliances, dedicated computer hardware devices, virtual server devices, personal computers, a system-on-a-chip (SOC), or any combination of these and/or other computing devices known in the art. In one example, components of systems disclosed herein are implemented on a single processing device. The processing device may provide an operating environment for software components to execute and utilize resources or facilities of such a system. An example of processing device(s) comprising such an operating environment is depicted in FIG. 5. In another example, the components of systems disclosed herein are distributed across multiple processing devices. For instance, input may be entered on a user device or client device and information may be processed on or accessed from other devices in a network, such as one or more remote cloud devices or web server devices.

According to an aspect, the system 100 includes a computing device 102 that may take a variety of forms, including, for example, desktop computers, laptops, tablets, smart phones, wearable devices, gaming devices/platforms, virtualized reality devices/platforms (e.g., virtual reality (VR), augmented reality (AR), mixed reality (MR)), etc. The computing device 102 has an operating system that provides a graphical user interface (GUI) that allows users to interact with the computing device 102 via graphical elements, such as application windows (e.g., display areas), buttons, icons, and the like. For example, the graphical elements are displayed on a display screen 104 of the computing device 102 and can be selected and manipulated via user inputs received via a variety of input device types (e.g., keyboard, mouse, stylus, touch, spoken commands, gesture).

In examples, the computing device 102 includes a plurality of content applications 108 for performing different tasks, such as web browsing, communicating, information generation and/or management, data manipulation, visual construction, resource coordination, calculations, etc. The content application 108 provides a source of input content that is to be incorporated into a prompt and evaluated by the language model 114. In some examples, the computing device 102 is a back-end server of a website other content generation platform. The content application 108 may be a data aggregator that aggregates content that is posted to the website. Other types of content applications 108 may also be considered or utilized with the technology described herein.

The content application(s) 108 may be local applications or web-based applications accessed via a web browser. Each content application 108 may have one or more application UIs 106 by which a user can view the content provided by the content application 108. For example, an application UI 106 may be presented on the display screen 104. In some examples, the operating environment is a multi-application environment by which a user may view and interact with multiple content applications 108 through multiple application UIs 106.

According to examples, the system 100 further includes a dynamic prompt generator 110 that dynamically generates prompts, as discussed herein. For example, the dynamic prompt generator 110 receives input content from the content application 108 that is to be evaluated (e.g., classified). Based on the input content, the dynamic prompt generator 110 generates a dynamic prompt using additional elements of the system 100.

In an example, the system 100 may also include a remote server 112 that includes a language model 114 and/or an embedding generator 116. The system 100 also includes a trait repository 118.

The trait repository 118 includes example pre-tagged data, which may also be referred to herein as trait data. For instance, the trait data may include content that has already been tagged with a known classification tag or label. In the example of performing misinformation classification, the trait data may include phrases that have been tagged as being misinformation of a particular type. The trait data may be organized by different traits (e.g., categories), and the trait data may include example content for each trait.

The trait repository 118 may be in the form of a database or other type of data store. The trait repository 118 may be stored on a separate computing device from the computing device 102 and/or the remote server 112. In other examples, the trait repository 118 is stored on the computing device 102 and/or the remote server 112.

As discussed further herein, rather than fine-tuning or otherwise training the language model 114 based on the trait data, the trait data is incorporated into the prompt generated by the dynamic prompt generator 110. By including the trait data in the prompt rather than re-training the language model 114, the technology disclosed herein can more efficiently handle trait data that changes frequently without having to adjust the language model 114 itself.

The embedding generator 116 generates embeddings for the input content and/or example data from the trait repository 118. For instance, as discussed further herein, the dynamic prompt generator 110 may request an embedding for the input content. The embedding generator 116 then generates the embedding for the input content.

That embedding for the input content may then be compared to embeddings for the trait data in the trait repository 118. Accordingly, in some examples, the embedding generator 116 also generates embeddings for the trait data in the trait repository 118. The embeddings for the trait data may also be stored with the trait data in the trait repository 118. While the embedding generator 116 is depicted as being part of the remote server 112, in other examples, the embedding generator 116 is executed on the computing device 102 or another device separate from the computing device 102 and/or the remote server 112.

An embedding may be considered a continuous, high-dimension vector representation of input data, such as the input content. In some examples, the vector representation captures the semantic and/or syntactic information about the input data. Many different types of embedding generator 116 may be used to generate the embeddings discussed herein, such as AdaV2, GPT, Word2Vec, GloVe, or FastText, among others.

The language model 114 processes the prompts generated by the dynamic prompt generator 110. The language model 114 may be an LLM, a multimodal model, or other type of generative AI model. Example models may include the GPT models from OpenAI, BARD from Google, and/or LLaMA from Meta, among other types of generative AI models. While the language model 114 is depicted as being part of the remote server 112, in other examples, the language model 114 is executed on the computing device 102 or another device separate from the computing device 102 and/or the remote server 112.

The improvement to the prompt similarly improves the performance of the language model 114, and results in the evaluation being completed more accurately and/or more efficiently with respect to computing resource utilization. Some evaluations that may be processed by the language model 114 may include the analysis of images or data to classify those images or data, such as a classification of a medical image or data to provide a classification (e.g., diagnosis). Other examples include classifying potentially harmful language or content. Further classifications may include audio-based analysis that analyzes, classifies, and/or otherwise transforms the audio content. Summarization, completion of text, question answering, translation, code writing, sentiment analysis, image capturing, data visualization interpretation, and/or object detection tasks, among others, may also be performed by the language model 114 and the enhanced prompts discussed herein. In examples where the evaluation or task performed by the language model includes the evaluation of non-textual data (e.g., images or audio), the trait data may also include pre-tagged data of the same modality (e.g., images or audio).

According to example implementations, the language model 114 is trained to understand and generate sequences of tokens, which may be in the form of natural language (e.g., human-like text). In various examples, the language model 114 can understand complex intent, cause and effect, perform language translation, semantic search classification, complex classification, text sentiment, summarization, summarization for an audience, and/or other natural language capabilities.

In some examples, the language model 114 is in the form of a deep neural network that utilizes a transformer architecture to process the text it receives as an input or query. The neural network may include an input layer, multiple hidden layers, and an output layer. The hidden layers typically include attention mechanisms that allow the language model 114 to focus on specific parts of the input text, and to generate context-aware outputs. Language model 114 is generally trained using supervised learning based on large amounts of annotated text data and learns to predict the next word or the label of a given text sequence.

The size of a language model 114 may be measured by the number of parameters it has. For instance, as one example of an LLM, the GPT-4 model from OpenAI has billions of parameters. These parameters may be weights in the neural network that define its behavior, and a large number of parameters allows the model to capture complex patterns in the training data. The training process typically involves updating these weights using gradient descent algorithms, and is computationally intensive, requiring large amounts of computational resources and a considerable amount of time. The language model 114 in examples herein, however, is pre-trained, meaning that the language model 114 has already been trained on the large amount of data. This pre-training allows the model to have a strong understanding of the structure and meaning of text, which makes it more effective for the specific tasks discussed herein.

The language model 114 may operate as a transformer-type neural network. Such an architecture may employ an encoder-decoder structure and self-attenuation mechanisms to process the input data (e.g., the prompt). Initial processing of the prompt may include tokenizing the prompt into tokens that may then be mapped to a unique integer or mathematical representation. The integers or mathematical representations combined into vectors that may have a fixed size. These vectors may also be known as embeddings.

The initial layer of the transformer model receives the token embeddings. Each of the subsequent layers in the model may uses a self-attention mechanism that allows the model to weigh the importance of each token in relation to every other token in the input. In other words, the self-attention mechanism may compute a score for each token pair, which signifies how much attention should be given to other tokens when encoding a particular token. These scores are then used to create a weighted combination of the input embeddings.

In some examples, each layer of the transformer model comprises two primary sub-layers: the self-attention sub-layer and a feed-forward neural network sub-layer. The self-attention mechanism mentioned above is applied first, followed by the feed-forward neural network. The feed-forward neural network may be the same for each position and apply a simple neural network to each of the attention output vectors. The output of one layer becomes the input to the next. This means that each layer incrementally builds upon the understanding and processing of the data made by the previous layers. The output of the final layer may be processed and passed through a linear layer and a softmax activation function. This outputs a probability distribution over all possible tokens in the model's vocabulary. The token(s) with the highest probability is selected as the output token(s) for the corresponding input token(s).

In example implementations, various components of the system 100 are distributed in different physical and/or network location. The components may communicate with one another using one or a combination of networks 105 (e.g., a private area network (PAN), a local area network (LAN), a wide area network (WAN)). In some examples, the different components may be implemented in a cloud-based environment or server-based environment using one or more cloud resources, such as server devices (e.g., web servers, file servers, application servers, database servers), personal computers (PCs), virtual devices, and mobile devices. The hardware of the cloud resources may be distributed across disparate regions in different geographic locations.

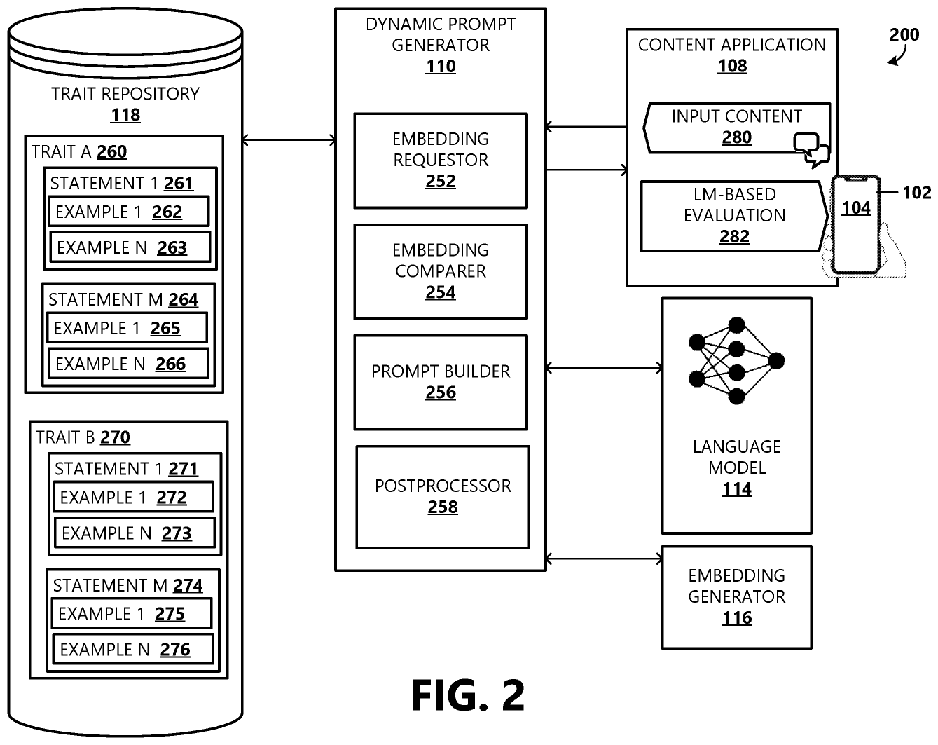

FIG. 2 is a block diagram of example components of an example dynamic prompt generation system 200. The example system 200 includes the dynamic prompt generator 110, the content application 108, the language model 114, the embedding generator 116, and the trait repository 118. In the example depicted, the dynamic prompt generator 110 further includes an embedding requestor 252, an embedding comparer 254, a prompt builder 256, and a postprocessor 258. The embedding requestor 252, the embedding comparer 254, the prompt builder 256, and the postprocessor 258 may be implemented as computing instructions (e.g., software and/or firmware) that, when executed by the respective processing system(s), cause the operations discussed herein to be performed.

In the example depicted, the content application 108 generates, receives, or otherwise accesses input content 280. The input content 280 is provided to the dynamic prompt generator 110. The input content 280 may be provided to the dynamic prompt generator 110 in response to a request from the dynamic prompt generator 110. In other examples, the input content 280 is provided to the dynamic prompt generator 110 as part of a request to evaluate the input content 280, such as request to classify the input content 280.

The dynamic prompt generator 110 receives the input content 280. The embedding requestor 252 generates a request for an embedding to be created for the input content 280. The embedding requestor 252 transmits the embedding request to the embedding generator 116, where the embedding generator 116 generates an embedding for the input content 280. The embedding generated for the input content 280 may be referred to herein as the input-content embedding. The input-content embedding is then provided back to the dynamic prompt generator 110.

In some examples, the embedding requestor 252 also generates a request for embeddings of the trait data stored in the trait repository 118. In examples where the embeddings for the trait data have already been generated and stored within the trait repository 118, the request for the embeddings is provided to the trait repository 118. The embeddings for the trait data are then returned to the dynamic prompt generator 110. In examples where the embeddings for the trait data have not already been generated, the request is provided to the embedding generator 116 with the trait data. The embeddings for the trait data are then generated by the embedding generator 116 and returned to the dynamic prompt generator 110. The embeddings for the trait data may be referred to herein as trait-data embeddings.

The embedding comparer 254 then compares the input-content embedding with the trait-data embedding to identify trait data that is similar to the input content 280. In some examples, comparison of the input-content embedding and the trait-data embedding is performed as a cosine similarity analysis performed over the vector space of the embeddings. For instance, the top N number of trait data may be identified based on the comparison. In such examples, the output of the embedding comparer 254 is a ranked list of trait data, where the ranking of the trait data is based on the similarity of the trait data to the input content 280. In other examples, the trait data that exceeds a similarity threshold when compared to the input data is identified by the embedding comparer 254 as similar to the input content 280. While primarily described herein as an embedding comparison, in other examples, the trait data that is most similar to the input content 280 is identified through other techniques, such as through the use of a separate classifier and/or machine learning (ML) model.

Based on the trait data that is found to be similar to the input content 280 (e.g., the trait data having the highest similarity with the input content 280), the prompt builder 256 builds a prompt. For instance, the prompt builder 256 includes the trait data that is found to be similar to the input content 280 into a prompt. The prompt builder 256 may include all the trait data that is found to be similar or subset of the trait data.

To further discuss an example of building the prompt, example trait data stored in trait repository 118 is depicted in FIG. 2. In the example, the trait data is organized by trait and includes multiple subcategories and examples. For instance, the trait data includes a first trait 260 and a second trait 270. The first trait 260 includes a plurality of statements (e.g., Statement 1 261 through Statement M 264) that correspond to the first trait 260. Each of the statements include examples of the statement. For example, Statement 1 261 includes a first example 262 through an Nth example 263. Similarly, Statement M 264 includes a first example 265 through an Nth example 266. The second trait 270 similarly includes a plurality of statements (e.g., Statement 1 271 through Statement M 274) that correspond to the second trait 270. Each of the statements also include examples of the statement. For instance, Statement 1 271 includes a first example 272 through an Nth example 273. Similarly, Statement M 274 includes a first example 275 through an Nth example 276. While the trait data is described primarily herein as being organized as traits, statements, and examples, it should be appreciated that the trait data may also be considered as categories (e.g., traits), sub-categories (e.g., statements), and examples. In addition, while trait data is primarily discussed herein as being in text form, in other examples, the trait data (and the input content 280) may include images, audio, and/or other modalities other than text.

As one non-limiting example for context that continues with the misinformation classification task discussed herein, the first trait 260 may be a “Misinformation QAnon” trait, and the statements (e.g., Statement 1 261 through Statement M 264) relate to statements that are known to be (e.g., pre-tagged as) misinformation related to QAnon. Such statements may include “a California law would legalize child endangerment” or “the president is a ‘shadow president’,” among others. Example content (e.g., prior posts or comments) that has been tagged as such statements of misinformation may then be included as examples 262-263 and examples 265-266 respectively.

The second trait 270 may be a “Misinformation U.S. Elections” trait, and the statements (e.g., Statement 1 270 through Statement M 264) relate to statements that are known to be misinformation related to the U.S. election. Such statements may include “using a Sharpie pen to vote will disqualify the ballot” or other similar statements. Example content (e.g., prior posts or comments) that has been tagged as statements of such misinformation may then be included as examples 272-273 and examples 275-276 respectively.

Returning to the prompt building operations, the prompt builder 256 identifies the trait data to incorporate into the prompt based on the similarity metrics of the trait data to the input content 280. As an example, the embeddings of all the statements in the trait data may be compared to the embedding of the input content 280. The statements may then be ranked based on the similarity of their embeddings to the input-content embedding. The top N number (e.g., top 5, 10, 15, 20) of statements are then identified as being similar to the input content 280.

The similar trait data that is then included into the prompt may be based on two different approaches: a conservative approach and an aggressive approach. In the conservative approach, for any statement that is identified as being similar to the input content 280 (e.g., any statement within the top N statements), all statements of the trait for which the statement belongs are included in the prompt. For example, if Statement 1 261 was in the top 10 statements from the similarity analysis, all of Statements 1 261 through Statement M 264 would be included in the prompt. In some instances, some or all of the examples corresponding to the statements of the trait may also be included in the prompt.

In contrast, in the aggressive approach, only the statements that are identified as being similar to the input content 280 (e.g., any statement within the top N statements) are included in the prompt. For example, if Statement 1 261 was in the top 10 statements from the similarity analysis and Statement M 264 was not in the top 10 statements, Statement 1 261 would be included in the prompt but Statement M 264 would not be included in the prompt. In some instances, some or all of the examples belonging to the identified statements are also included in the prompt.

The use of the conservative approach versus the aggressive approach provides tradeoffs between evaluation coverage and computational resource utilization. For instance, in the conservative approach, the prompt becomes longer and requires more resources to process, but the resultant evaluation from the language model 114 is more likely to capture potential classifications of the input content. The aggressive approach results in a shorter prompt that requires fewer resources to process, but the resultant evaluation from the language model 114 may potentially miss classifications based on trait data that is omitted from the prompt. With either approach, however, computing resources are conserved as compared to incorporating all the trait data within the prompt.

Generation of the prompt, in some examples, includes accessing a template that includes static segments and dynamic segments with placeholders for dynamic data, such as the identified similar trait data and the input content 280. The static segments may include instructions and requests for the language model 114 that define and explain the particular evaluation task that is being requested. The static segments may also include formatting instructions that instruct how the output from the language model 114 should be formatted. One example prompt template is provided below:

```
<STATIC INITIAL INSTRUCTIONS>
  You are a moderator and your job is to determine if a given comment falls
  under any of the given misinformation statements. Your job is to carefully
  read the statements provided below and identify if the given comment falls
  under any of the statements.
  * A comment does not fall under a statement if the comment ONLY hints
  towards a statement, or if there is a vague reference to a statement.
  * Quoting from another source, questioning, discouraging, or disagreeing with
  a statement does not yield falling under that statement.
  * A comment falls under a statement only if the comment clearly supports the
  statement.
</STATIC INITIAL INSTRUCTIONS>
<DYNAMIC SIMILAR TRAIT DATA>
  [SIMILAR TRAIT DATA PLACEHOLDER]
</DYNAMIC SIMILAR TRAIT DATA>
<STATIC CLARIFYING INSTRUCTIONS>
  You will be asked to identify if a given comment falls under any of the given
  misinformation statements. Note that the comment could be completely
  irrelevant to the provided statements above. Your only source of information
  is the comment itself. Please do not look for hidden links or suggestions in the
  given comment. A vague reference to a statement is not enough to fall a
  comment under a statement. The comment has to clearly support a statement,
  which means the comment has similar meaning with the statement or is a
  rephrase of the statement.
</STATIC CLARIFYING INSTRUCTIONS>
</STATIC OUTPUT INSTRUCTIONS>
  You must respond as a JSON in the following format and finish your response
  with @. Your response JSON object must contain the “Statement” key:
  “Relevant Score”: {{A decimal number from 0.0 to 1.0. Smaller number
  means comment is less relevant to the statement. Bigger number means
  comment is more relevant to the statement.}},
  “Justification”: “{{A very brief justification for you judgment, maximum 100
  tokens}}”,
  “Statements”: {{list of statements that the comment falls under them, only use
  statement number. If none, it should an empty list}}
  Please identify if this comment falls under any of the given statements.
<DYNAMIC INPUT CONTENT>
  [INPUT CONTENT PLACEHOLDER]
</DYNAMIC INPUT CONTENT>
```

In the above example prompt, static initial instructions are included that provide an evaluation task and role for the language model 114 along with additional guidance. The similar trait data (e.g., trait data that is identified as similar to the input content) is populated into the similar trait data placeholder of the dynamic similar trait data segment of the prompt. Static clarifying instructions are also included in the prompt that further clarify the task and place additional restrictions on the task that is to be performed. The example prompt further includes static output instructions that define how the output is to be provided by the language model 114. In the example provided above, the output instructions request that the output includes a relevancy score, a justification, and the particular trait data (e.g., statement(s)) that input content 280 is found to fall under (e.g., classified as). In addition, the input content 280 is provided into the input content placeholder of the dynamic input content segment of the prompt.

The prompt is formed by the prompt builder 256 by populating the prompt template with the dynamic data (e.g., the similar trait data and the input content 280). The prompt is then transmitted to the language model 114 for processing. The language model 114 processes the prompt and generates an output payload that includes the evaluation of the input content 280, such as a classification of the input content 280. The output payload from the language model 114 is received by the dynamic prompt generator 110, and the postprocessor 258 may postprocess the output payload.

The postprocessing operations may include parsing the output payload to extract defined segments of the output payload. The parsing may be possible (or at least improved) due to the formatting of the output payload that is caused by the output formatting instructions provided in the prompt. The post-processing may also include filtering or cleaning the output payload to ensure inappropriate content was not provided by the language model 114 (in addition to the input content 280 and trait data). The post-processing also includes further formatting of the data in the output payload into user interface features that may be displayed on a user interface of the display screen 104.

The postprocessing operations of the postprocessor 258 also include extracting the LM-based evaluation of the input content 280 from the output payload received from the language model 114. In some examples, extracting the evaluation of the input content is straightforward where there is only a single evaluation, such as a single classification. In other examples, the output payload includes multiple potential evaluations (e.g., classifications). For instance, the output payload may propose that the input content is potentially classified under two different statements (e.g., subcategories). The postprocessor 258 may extract both classifications. In some examples, the output payload includes a relevant score for the classifications that are proposed in the output payload. Such relevant scores are provided when such scores are requested by the prompt, such as in the example prompt discussed above. The postprocessor 258 may then select only the classifications that have a corresponding score above a threshold level. The selected classifications are then be provided as the LM-based evaluation. In some examples where a justification is also provided for the proposed classifications, the justification is also be provided with the selected classifications as the LM-based evaluation.

The LM-based evaluation 282 that is extracted from the output payload is then provided to the content application 108. In other examples, the LM-based evaluation 282 is provided to another application other than the content application 108. In some examples, the LM-based evaluation is caused to be displayed on the display screen 104 of the computing device 102.

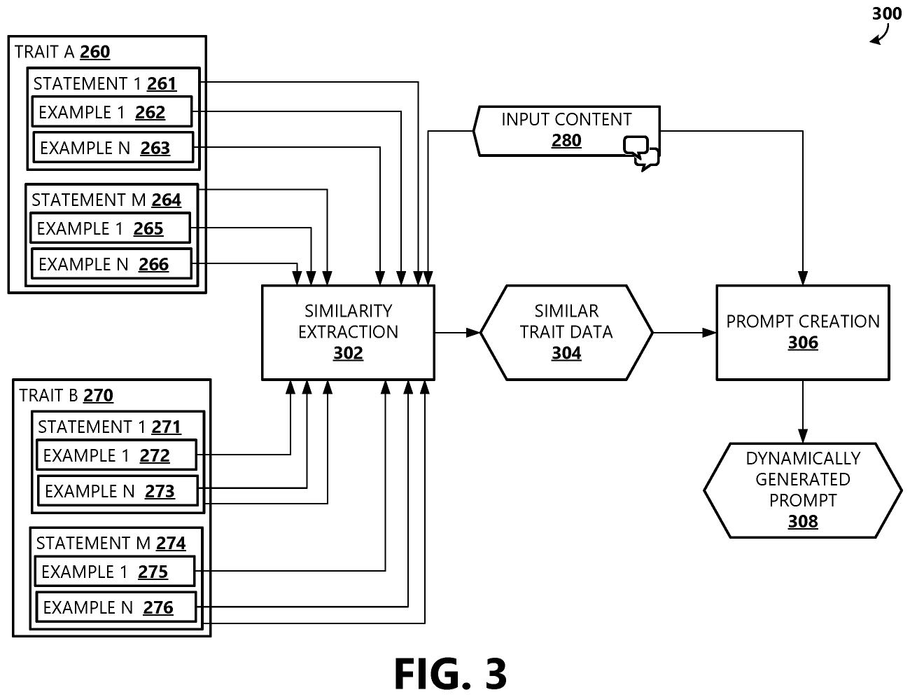

FIG. 3 is an example data flow 300 for dynamically generating a prompt. The trait data that is shown in FIG. 2 has also been depicted in FIG. 3. As shown in FIG. 3, the trait data and the input content 280 are provided as input into a similarity extraction function 302. The similarity extraction function 302 identifies the trait data that is similar to the input content 280, and the similarity extraction function 302 provides the similar trait data 304 as output. As discussed herein, this similarity extraction function 302 may include generating a ranked list of the trait data that is most similar to the input content 280. The top N number of trait data may then be identified as the similar trait data 304.

The comparison of the trait data to the input content 280 may be performed on a trait level (e.g., category level), a statement level (e.g., a subcategory level), and/or an example level. For instance, embeddings of the statements (e.g., subcategories) may be compared to the embedding of the input content 280. In such examples, the similarity extraction function 302 may generate a ranked list of statements (e.g., subcategories) based on their similarity to the input content 280. Additionally or alternatively, embeddings of examples in the trait data may be compared to the embedding of the input content 280. In such examples, the similarity extraction function 302 may generate a ranked list of statements (e.g., subcategories) based on their similarity to the input content 280.

With the similar trait data 304 identified, the prompt is then created at the prompt creation function 306. In examples, the prompt creation function 306 includes accessing a prompt template and filling the prompt template with the input content 280 and the similar trait data 304. As such, the inputs to the prompt creation function 306 include at least the input content 280 and the similar trait data. The output of the prompt creation function 306 is the dynamically generated prompt 308.

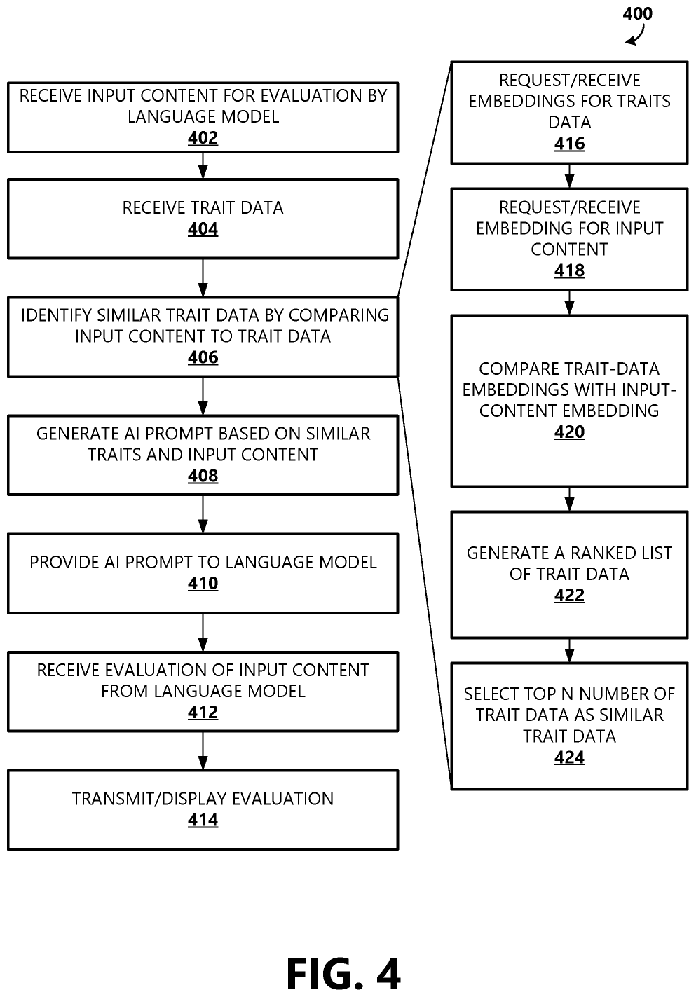

FIG. 4 is an example method 400 for dynamically generating a prompt. The operations of method 400 may be performed by one or more the devices of the systems discussed herein. For instance, a computing device (such as server or cloud computing device) may include at least one processor and memory storing instructions that, when executed by the at least one processor, cause the operations of method 400 to be performed. As an example, the operations of method 400 may be performed by the dynamic prompt generator 110 of systems 100 or 200, depicted in FIGS. 1-2 respectively.

At operation 402, input content is received for evaluation by a language model. The input content may be received as part of a request to the evaluate the input content. In some examples, the input content is generated by and/or received from a content application. The input content may include various types of content that is to be evaluated (e.g., classified). The input content may take a variety of forms, such as documents, websites, social media posts, comments, messages, and/or data extracted therefrom, among other types of content to be evaluated.

At operation 404, trait data is received. The trait data may be the types of trait data discussed herein, and in some examples the trait data is received from a trait repository. In examples where the trait repository is a local repository, receiving the trait data includes accessing the trait data. In some examples, the trait data that is received is based on the particular evaluation task that is being requested. As an example, if the evaluation task is a classification task to identify misinformation in the input data, a first set of trait data is received that relates to misinformation trait data. If, however, the evaluation task is a different task (e.g., a different classification task or another task altogether), a second or different set of trait data is received that relates to the particular evaluation task. The different types of trait data may also be stored in different trait repositories. As such, in those examples, depending on the particular evaluation task, the trait data is received from different sources (e.g., different trait repositories).

At operation 406, the input content is compared to the received trait data to identify trait data that is similar to the input content. The comparison and identification of the trait data and the input content may be performed in a variety of manners. In some examples, the trait data and the input data are provided as input into a classifier or other ML model that provides, as output, the trait data that is similar to the input data. In other examples, embeddings of the trait data and an embedding of the input content are used to identify the input content. Example operations using the embeddings in such a manner are depicted in operations 416-424.

At operation 416, embeddings for the trait data are requested and/or received. The trait-data embeddings may have been previously generated and stored with the trait data. In such examples, operation 416 may be performed as part of operation 404. For instance, the trait-data embeddings are received with the trait data itself. In other examples, the trait-data embeddings have not been previously generated. In such examples, operation 416 includes transmitting a request to an embeddings generator generate the trait-data embeddings, which are then received and used in the similarity determinations discussed herein.

The trait data embeddings may include embeddings for one or more of the various levels of the trait data. For instance, embeddings may be received for the traits (e.g., categories), the statements (e.g., subcategories), and/or the examples of the trait data.

At operation 418, a request for an embedding of the input content is generated and transmitted to an embedding generator. The input-content embedding is then received from the embedding generator.

At operation 420, the trait-data embeddings are compared to the input-content embedding to identify the trait data that is similar to the input content. In some examples, the comparison includes performing a cosine similarity of the embeddings. The cosine similarity analysis of the embeddings (which are multidimensional vectors) provides a measure of how close the embeddings are in the multidimensional space. In such examples, the comparison of each trait-data embedding and the input-content embedding results in a similarity score, which may be a cosine similarity score (e.g., −1 to 1 with a score of 1 indicating an identical vector).

At operation 422, a ranked list of trait data may be generated based on the comparison of the trait-data embeddings and the input-content embedding performed at operation 420. As an example, the trait data is ranked according to the similarity score (e.g., cosine similarity score) generated in operation 420. At operation 424, a top N number (e.g., a predefined number such as 5, 10, 15, 20) of trait data are identified as the similar trait data.

The method 400 then proceeds to operation 408 where a prompt is dynamically generated based the identified similar trait data and the input content. In some examples, operation 408 includes accessing a prompt template. Operation 408 then populates the prompt template with the input content and a subset of the trait data based on the identified similar trait data.

In examples, the prompt template that is accessed is based on the type of evaluation task that is requested for the input content. For instance, the prompt template may be accessed from a plurality of different prompt templates that are each specific to a different evaluation task. As an example, if the evaluation task is a classification task to identify misinformation in the input data, a first prompt template is accessed that relates to misinformation trait data. If, however, the evaluation task is a different task (e.g., a different classification task or another task altogether), a second or different prompt template is accessed that relates to the particular evaluation task. In either case, the prompt template includes a dynamic placeholder for the input content and a dynamic placeholder for the similar trait data.

In some examples, the trait data that is populated in the dynamic placeholder of the trait data is identified according to a conservative approach and an aggressive approach. In the conservative approach, for any statements (e.g., subcategory) of the trait data that is in the similar trait data, all statements (e.g., subcategories) of the trait (e.g., category) for which the statement (e.g., subcategory) belongs are included in the prompt. In some instances, the examples corresponding to the statements (e.g., subcategory) of the trait (category) are also included in the prompt. In the aggressive approach, only the statements (e.g., subcategories) that are identified in the similar trait data are included in the prompt. In some instances, the examples belonging to the identified statements (e.g., subcategories) are also included in the prompt.

At operation 410, the prompt that was generated in operation 408 is provided to the language model for processing by the language model. The language model processes the received prompt and generates an output payload including the requested evaluation of the input content. At operation 412, the output payload with the requested evaluation is received.

The output payload may be formatted and include types of data that were requested in the prompt. For instance, in the example prompt discussed above, a relevant score, a justification, and the statements (e.g., subcategories) for which the input data falls under (e.g., more closely matches) are requested, and such data is returned in the output payload received from the language model.

Operation 412 may also include postprocessing the output payload to extract the requested evaluation of the input content. In examples, postprocessing includes parsing the output payload to extract defined segments of the output payload, such as the LM-based evaluation of the input content. For instance, in some examples, the output payload includes multiple potential evaluations (e.g., classifications), such as indications that the input content is potentially classified under two different statements (e.g., subcategories). The output payload may also include a relevant score for the evaluations (e.g., classifications) that are proposed in the output payload. Postprocessing the output payload may include selecting only the proposed evaluations that have a corresponding relevant score above a threshold level. The selected classifications are then be provided as the LM-based evaluation of the input content. In some examples where a justification is also provided for the proposed classifications, the justification may also be included with the selected classifications as the LM-based evaluation.

The postprocessing may also include filtering or cleaning the output payload to ensure inappropriate content was not provided by the language model (in addition to the input content and trait data). In some examples, the post-processing also includes further formatting of the data in the output payload into user interface features that may be displayed on a user interface.

At operation 414, the LM-based evaluation extracted from the output payload is transmitted and/or caused to be displayed. In an example, the extracted evaluation is transmitted to the application and/or device that initially provided the request and/or input content in operation 402. In other examples, the extracted evaluation may be displayed on a display of the device executing the operations of method 400.

Additional actions may also be taken based on the evaluation that is received. For instance, the input content may be automatically tagged or flagged based on the evaluation. Such a tagging or flagging of content may result in additional modifications of the input content at its source location. For instance, continuing with the misinformation example discussed herein, if the input content is classified as misinformation, the input content may be displayed with an indicator that indicates the input content may be misinformation. In other examples, the input content is removed from display in the content application.

The method 400 may be repeated for additional or new input content that is to be evaluated using the dynamic prompt generation technology described herein. Each time that the method 400 is performed, not only may the input content change, but the trait data may also change. For instance, through the dynamic use of the trait data discussed herein, the trait data can be easily updated and changed without requiring significant changes to the underlying technology or operations. As an example, updating the trait data may be accomplished by simply changing the entries within the respective trait repositories. Thus, the prompts ultimately generated from such trait data are similarly updated, which allows for evaluations that can readily track current events or other types of changing data.

FIG. 5 is a block diagram illustrating physical components (e.g., hardware) of a computing device 500 with which examples of the present disclosure may be practiced. The computing device components described below may be suitable for one or more of the components of the systems described above. In a basic configuration, the computing device 500 includes at least one processing system 502 and a system memory 504. The processing system 502 may include one or more processors. Depending on the configuration and type of computing device 500, the system memory 504 may comprise volatile storage (e.g., random access memory), non-volatile storage (e.g., read-only memory), flash memory, or any combination of such memories. The system memory 504 may include an operating system 505 and one or more program modules 506 suitable for running software applications 550 (e.g., one or more dynamic prompt generators 110) and other applications.

The operating system 505 may be suitable for controlling the operation of the computing device 500. Furthermore, aspects of the disclosure may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 504. While executing on the processing system 502, the program modules 506 may perform processes including one or more of the stages of the method 400 illustrated in FIG. 4. Other program modules that may be used in accordance with examples of the present disclosure and may include applications such as electronic mail and contacts applications, word processing applications, spreadsheet applications, database applications, slide presentation applications, drawing or computer-aided application programs, etc.

Furthermore, examples of the disclosure may be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to detecting an unstable resource may be operated via application-specific logic integrated with other components of the computing device 500 on the single integrated circuit (chip). Examples of the present disclosure may also be practiced using other technologies capable of performing logical operations such as, for example, AND, OR, and NOT, including mechanical, optical, fluidic, and quantum technologies.

The computing device 500 may also have one or more input device(s) 512 such as a keyboard, a mouse, a pen, a sound input device, a touch input device, a camera, etc. The output device(s) 514 such as a display, speakers, a printer, etc. may also be included. The aforementioned devices are examples and others may be used. The computing device 500 may include one or more communication connections 516 allowing communications with other computing devices 518. Examples of suitable communication connections 516 include RF transmitter, receiver, and/or transceiver circuitry; universal serial bus (USB), parallel, and/or serial ports.

The term computer readable media as used herein includes volatile and nonvolatile, removable and non-removable media implemented in any method or technology for storage of information, such as computer readable instructions, data structures, or program modules. The system memory 504, the removable storage device 509, and the non-removable storage device 510 are all computer readable media examples (e.g., memory storage.) Computer readable media include random access memory (RAM), read-only memory (ROM), electrically erasable programmable ROM (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer readable media may be part of the computing device 500. Computer readable media does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, communication media may include wired media such as a wired network or direct-wired connection, and wireless media such as acoustic, RF, infrared, and other wireless media.

In an aspect, the technology relates to a system for dynamically generating prompts for a language model. The system includes at least one processor and memory storing instructions that, when executed by the at least one processor, cause the system to perform operations. The operations include receive input content for evaluation by the language model; receive trait data that includes pre-tagged data; identify similar trait data by comparing the received trait data to the input content, wherein the similar trait data is a subset of the trait data that is similar to the input content; generate a prompt including the input content and data based on the identified similar trait data; provide the prompt to the language model; and receive, from the language model in response to the prompt, an output payload including an evaluation of the input content.

In an example, the operation of identifying the similar trait data further includes receive an input-content embedding for the input content; receive trait-data embeddings for the trait data; and identify the similar trait data by comparing the trait-data embeddings with the input-content embedding. In a further example, comparing the trait-data embeddings with the input-content embedding comprises performing a cosine similarity analysis. In another example, identifying the similar trait data by comparing the trait-data embeddings with the input-content embedding includes: generate a ranked list of trait data based on a similarity of the trait-data embeddings to the input-content embedding; and select a top N number of trait data, from the ranked list, as the similar trait data. In yet another example, the data based on the identified similar trait data is the similar trait data and the remainder of the trait data is omitted from the prompt. In a still further example, the data based on the identified similar trait data further comprises examples of the identified similar trait data.

In another example, the trait data includes traits and statements; the similar trait data includes at least one statement from a particular trait; and the data based on the identified similar trait data includes all the statements from the particular trait and statements from other traits in the trait data are omitted from the prompt. In still another example, the output payload comprises relevant scores for a plurality of proposed evaluations for the input content, and the operations further include postprocess the output payload to identify proposed evaluations that have relevant scores exceeding a threshold; and at least one of transmit or cause display of the proposed evaluations having the relevant scores exceeding the threshold. In yet another example, the evaluation of the input content is a classification of the input content.

In another aspect, the technology relates to a computer-implemented method for dynamically generating prompts for a generative artificial intelligence (AI) model. The method includes receiving input content for evaluation by a generative AI model; receiving an input-content embedding for the input content; receiving trait data and trait-data embeddings for the trait data; identifying similar trait data by comparing the input-content embedding with the trait-data embeddings, wherein the similar trait data is a subset of the trait data that is similar to the input content; generating a prompt including the input content and the identified similar trait data; providing the prompt to the generative AI model; and receiving, from the generative AI model in response to the prompt, an output payload including an evaluation of the input content.

In an example, trait data other than the similar trait data is omitted from the prompt. In another example, identifying the similar trait data by comparing the trait-data embeddings with the input-content embedding includes generating a ranked list of trait data based on a similarity of the trait-data embeddings to the input-content embedding; and selecting a top N number of trait data, from the ranked list, as the similar trait data. In still another example, the prompt further includes examples of the identified similar trait data. In yet another example, the trait data includes categories and subcategories; the similar trait data includes at least one subcategory from a particular category; and the prompt further comprises all the subcategories from the particular category. In still yet another example, the output payload comprises relevant scores for a plurality of proposed evaluations for the input content, and the method further includes postprocessing the output payload to identify proposed evaluations that have relevant scores exceeding a threshold. In another example, the trait data includes data that is pre-tagged with classifications, and wherein the evaluation of the input content is a classification of the input content as one of the pre-tagged classifications.

In another aspect, the technology relates to a computer-implemented method for dynamically generating prompts for a language model. The method includes receiving input content for classification by a language model; requesting an embedding for the input content; receiving, in response to the request, an input-content embedding for the input content; receiving trait data comprising statements pre-tagged with classifications; receiving trait-data embeddings that include embeddings of the statements; identifying similar statements by comparing the input-content embedding with the trait-data embeddings, wherein the similar statements are the statements that are similar to the input content; generating a prompt including the input content and the identified similar statements; providing the prompt to the language model; and receiving, from the language model in response to the prompt, an output payload including a classification of the input content.

In another example, the classification of the input content is one of the pre-tagged classifications of the similar statements. In still another example, the prompt does not include statements, in the trait data, that are not identified as the similar statements. In yet another example, identifying the similar statements by comparing the trait-data embeddings with the input-content embedding includes generating a ranked list of statements based on a similarity of the trait-data embeddings to the input-content embedding; and selecting a top N number of statements, from the ranked list, as the similar statements.

Aspects of the present invention, for example, are described above with reference to block diagrams and/or operational illustrations of methods, systems, and computer program products according to aspects of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. Further, as used herein and in the claims, the phrase “at least one of element A, element B, or element C” is intended to convey any of: element A, element B, element C, elements A and B, elements A and C, elements B and C, and elements A, B, and C.

The description and illustration of one or more examples provided in this application are not intended to limit or restrict the scope of the invention as claimed in any way. The aspects, examples, and details provided in this application are considered sufficient to convey possession and enable others to make and use the best mode of claimed invention. The claimed invention should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope of the claimed invention.

Although the disclosure provides specific examples, various modifications and changes can be made without departing from the scope of the disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to a specific example are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A system for dynamically generating prompts for a language model, the system comprising:
at least one processor; and
memory storing instructions that, when executed by the at least one processor, cause the system to perform operations comprising:
receive input content for evaluation by the language model;
receive trait data that includes pre-tagged data;
identify similar trait data by comparing the received trait data to the input content, wherein the similar trait data is a subset of the trait data that is similar to the input content;
generate a prompt including the input content and data based on the identified similar trait data;
provide the prompt to the language model; and
receive, from the language model in response to the prompt, an output payload including an evaluation of the input content.

2. The system of claim 1, wherein the operation of identifying the similar trait data further comprises:
receive an input-content embedding for the input content;
receive trait-data embeddings for the trait data; and
identify the similar trait data by comparing the trait-data embeddings with the input-content embedding.

3. The system of claim 2, wherein comparing the trait-data embeddings with the input-content embedding comprises performing a cosine similarity analysis.

4. The system of claim 2, wherein identifying the similar trait data by comparing the trait-data embeddings with the input-content embedding comprises:
generate a ranked list of trait data based on a similarity of the trait-data embeddings to the input-content embedding; and
select a top N number of trait data, from the ranked list, as the similar trait data.

5. The system of claim 1, wherein the data based on the identified similar trait data is the similar trait data and the remainder of the trait data is omitted from the prompt.

6. The system of claim 5, wherein the data based on the identified similar trait data further comprises examples of the identified similar trait data.

7. The system of claim 1, wherein:
the trait data includes traits and statements;
the similar trait data includes at least one statement from a particular trait; and
the data based on the identified similar trait data includes all the statements from the particular trait and statements from other traits in the trait data are omitted from the prompt.

8. The system of claim 1, wherein the output payload comprises relevant scores for a plurality of proposed evaluations for the input content, and the operations further comprise:
postprocess the output payload to identify proposed evaluations that have relevant scores exceeding a threshold; and
at least one of transmit or cause display of the proposed evaluations having the relevant scores exceeding the threshold.

9. The system of claim 1, wherein the evaluation of the input content is a classification of the input content.

10. A computer-implemented method for dynamically generating prompts for a generative artificial intelligence (AI) model, the method comprising:
receiving input content for evaluation by a generative AI model;
receiving an input-content embedding for the input content;
receiving trait data and trait-data embeddings for the trait data;
identifying similar trait data by comparing the input-content embedding with the trait-data embeddings, wherein the similar trait data is a subset of the trait data that is similar to the input content;
generating a prompt including the input content and the identified similar trait data;
providing the prompt to the generative AI model; and
receiving, from the generative AI model in response to the prompt, an output payload including an evaluation of the input content.

11. The method of claim 10, wherein trait data other than the similar trait data is omitted from the prompt.

12. The method of claim 10, wherein identifying the similar trait data by comparing the trait-data embeddings with the input-content embedding comprises:
generating a ranked list of trait data based on a similarity of the trait-data embeddings to the input-content embedding; and
selecting a top N number of trait data, from the ranked list, as the similar trait data.

13. The method of claim 10, wherein the prompt further includes examples of the identified similar trait data.

14. The method of claim 10, wherein:
the trait data includes categories and subcategories;
the similar trait data includes at least one subcategory from a particular category; and
the prompt further comprises all the subcategories from the particular category.

15. The method of claim 10, wherein the output payload comprises relevant scores for a plurality of proposed evaluations for the input content, and the method further comprises postprocessing the output payload to identify proposed evaluations that have relevant scores exceeding a threshold.

16. The method of claim 10, wherein the trait data includes data that is pre-tagged with classifications, and wherein the evaluation of the input content is a classification of the input content as one of the pre-tagged classifications.

17. A computer-implemented method for dynamically generating prompts for a language model, the method comprising:
receiving input content for classification by a language model;
requesting an embedding for the input content;
receiving, in response to the request, an input-content embedding for the input content;
receiving trait data comprising statements pre-tagged with classifications;
receiving trait-data embeddings that include embeddings of the statements;
identifying similar statements by comparing the input-content embedding with the trait-data embeddings, wherein the similar statements are the statements that are similar to the input content;
generating a prompt including the input content and the identified similar statements;
providing the prompt to the language model; and
receiving, from the language model in response to the prompt, an output payload including a classification of the input content.

18. The method of claim 17, wherein the classification of the input content is one of the pre-tagged classifications of the similar statements.

19. The method of claim 17, wherein the prompt does not include statements, in the trait data, that are not identified as the similar statements.

20. The method of claim 19, wherein identifying the similar statements by comparing the trait-data embeddings with the input-content embedding comprises:
generating a ranked list of statements based on a similarity of the trait-data embeddings to the input-content embedding; and
selecting a top N number of statements, from the ranked list, as the similar statements.
